(19) United States
(12) Patent Application Publication
(10) Pub. No.: US 2013/0173240 A1
(43) Pub. Date: Jul. 4, 2013

(54) METHOD AND DEVICE FOR DYNAMICALLY DETERMINING THE POSITION AND ORIENTATION OF THE BONE ELEMENTS OF THE SPINE

(71) Applicants: Perrine Koell, Bordeaux (FR); Raphael Dumas, Villeurbanne (FR); Fouad Elbaroudi, Sainte Adresse (FR); Laurence Cheze, Lyon (FR)

(72) Inventors: Perrine Koell, Bordeaux (FR); Raphael Dumas, Villeurbanne (FR); Fouad Elbaroudi, Sainte Adresse (FR); Laurence Cheze, Lyon (FR)

(73) Assignees: UNIVERSITE LYON 1 CLAUDE BERNARD, VILLEURBANNE (FR); AXS INGENIERIE, Le Havre (FR)

(21) Appl. No.: 13/818,718

(22) PCT Filed: Aug. 24, 2011
(86) PCT No.: PCT/FR2011/051961

§ 371 Date: Mar. 14, 2013

(30) Foreign Application Priority Data
Aug. 25, 2010 (FR) 1056765

(51) Int. Cl. G06F 17/50

(52) U.S. Cl. CPC G06F 17/5009
USPC 703/2

(57) ABSTRACT

A method for dynamically determining the position and orientation of the bone elements of the spine of a person by internal imaging, includes: calculating in a first stage t, the relationships of the vertebrae to one another and relative to the surface of the back; determining equations for a dynamic mechanical model of the spine and for internal stresses on the spine and interactions between the spine and the surface of the back; producing in a second stage t+1, 3D images of the outer surface of the back of the person; and determining for stage t+1, the position and orientation of each of the vertebrae from data acquired from 3D images of the outer surface of the back during stage t+1 and from static position and orientation of data calculated for each of the vertebrae as well as for the shape of the surface of the back during stage t.

The present invention relates to a method for dynamically determining the position and orientation of the bone elements of the spine as well as a device adapted for that purpose. It has applications in the field of imaging, in particular medical imaging. The possible uses of the present invention are non-invasive follow-up and diagnosis of spinal pathologies, as well as studies about spinal mobility, more particularly pseudo-kinematic studies, i.e. between static positions.

There is today an increasing interest about the personalized three-dimensional (3D) reconstruction of the vertebral column, for analysis of the spine posture and mobility. Several methods have been developed to deduce the configuration of the vertebral column based on external data (surface of the back or cutaneous markers).

Therefore, it is known by the document WO 2008/012479 A1 a method for three-dimensional reconstruction of an individual's spine and of the relationships thereof with the surface of the back based on conventional two-dimensional radiographs and three-dimensional imaging of the surface of the back. For that purpose, an iterative calculation means using digitized data of said radiographs and of the surface imaging is implemented. Marks visible on a radiograph and on the surface of the back are used. This method is static in that, if it is desired to obtain a new reconstruction of the spine of said individual after his/her spine has moved or has been deformed, it is necessary to repeat the whole process with new radiographs and new 3D images of the surface of the individual's back. It results therefrom that the individual has to be irradiated once again by X-rays and that a new radiograph processing (often tedious, as for example for identifying anatomical points) has to be restarted from zero. The raw or calculated information obtained during the first reconstruction are of no use for the second reconstruction of the spine.

Yet, it is useful to have information about the spine of an individual for several positions or during the evolution of the deformations of this spine. It is therefore desirable to have a dynamic method for three-dimensional reconstruction of the spine, which uses at best the available data, whether the latter are raw (resulting from two-dimensional radiographic images and from the three-dimensional images of the back, or from other methods for 3D reconstruction of the spine) or result from calculations (3D reconstruction of the spine and spine/back surface relationships). It is also desirable that the individual should not be subjected to a significant X-radiation and thus that the number of radiographs should be reduced to the strict minimum.

Further, in the field of spine movement analysis, kinematic models have been elaborated based on one or several initial configurations, for example using one or more radiographs and cutaneous markers with a view to obtain other configurations (continuously or not). However, the kinematics of the spine is very complex due to the high number of articulated vertebrae and the resolution is constrained if there are not enough cutaneous markers. Therefore, complex laws of coordination must often be implemented to use such kinematics models because the number of external markers would be too prohibitive to follow the entire spine. For those reasons, only the cervical and lumbar models have been developed up to now, and only in the sagittal plane. Such models have for example been proposed in the following documents:
Zhang, Xiong, “Model-guided derivation of lumbar vertebral kinematics in vivo reveals the difference between external marker-defined and internal segmental rotations”, Journal of biomechanics, vol. 36, pp 9-17, 2003;
Sun, Lee, Lu, Luk, “Modeling and simulation of the intervertebral movements of the lumbar spine using an inverse kinematic algorithm”, Med. Biol. Eng. Comput., vol. 42, pp. 740-746, 2004; and
F. Marin, N. Hoang, P. Aufaure, M.-C. Ho Ba Tho, “In vivo intersegmental motion of the cervical spine using an inverse kinematics procedure”, Clinical Biomechanics, vol. 25, pp. 389-396, 2010.

In the field of follow-up, non-invasive diagnosis and planning of treatment (surgical or orthopedic), dynamic mathematical, finite element and multi-body models have been developed. The mathematical models are based on statistical correlations or geometrical relationships between the vertebral column and the surface of the back, as explained in the following documents:
B. Drerup, E. Hierholtzer, “Back shape measurement using video rasterstereography and three-dimensional reconstruction of spinal shape”, Clinical Biomechanics, vol. 9, pp. 28-36, 1994;
Huysmans, Haex, Van Audekercke, Vander Sloten, Van der Perre, “Three-dimensional mathematical reconstruction of the spinal shape, based on active contours”, Journal of Biomechanics, vol. 37, pp. 1793-1798, 2004; and
D'amico M, D'amico G, Roncoletta, Tomassini, Ciarrocca, Vallasciani, “A 3-D biomechanical skeleton model and processing procedure for posture and movement analysis”, Europa Medicophysica, vol. 43, pp. 1-6, 2007.

The advantage of these latter mathematical models is their easiness of implementation, but the spine is not personalized. In the finite element models, an initial geometry and laws of behavior of the materials have to be determined. Until now, such models are mainly used to simulate medical acts: surgical operations (Lafage, Dubousset, Lavaste, Skalli, “3D finite element simulation of cotrel-dubousset correction”, Computer Aided Surgery, vol. 9, pp. 17-25, 2004) or spinal brace fitting (D. Périé, C.-E. Aubin, M. Lacroix, Y. Lafon, H. Labelle, “Biomechanical modeling of orthotic treatment of the scoliotic spine including a detailed representation of the brace-torso interface”, Med. Biol. Eng. Comput, vol. 42, pp. 339-344, 2004). Regarding the multi-body dynamic models, an initial configuration, as well as the positions of the articular centers and the stiffness of their links, must be determined. Such models do not include additional constraints, such as, for example, correlations between the spine and the surface of the back. Up to now, such models are used to simulate surgical operations (Aubin, Petit, Stokes, Poulin, Gardner-Morse, Labelle, “Biomechanical modeling of posterior instrumentation of the scoliotic spine”, Computer methods in biomechanics and biomedical engineering, vol. 21, pp. 77-88, 2003, or Y. Petit, C-E. Aubin, H. Labelle, “Patient-specific mechanical properties of a flexible multi-body model of the scoliotic spine”, Medical & Biological Engineering & Computing, vol. 42, pp. 55-60, 2004).

To remedy the known technical limitations, it is proposed to implement a predictive dynamic model of the spine configuration. Such personalized dynamic model has for object to predict the position and orientation of the vertebrae of a spine at a time t+1, knowing the positions and orientation thereof at the time t, as well as the position of the back surface at the times t and t+1. Thanks to this dynamic model of spine, it is possible to three-dimensionally reconstruct the spine at a time t+1, based on a simple 3D image of the back surface at said time t+1, and using information previously obtained, at a previous time t, before the displacement/deformation of the individual's spine, in particular based on biplanar digital radiographs, preferably only two radiographs, and 3D external imaging of the back surface at the previous time t, and which are processed with a method for 3D reconstruction of the spine and of the surface of the back at this previous time t. The method used at this previous time t for 3D reconstruction of spine is preferably the method that is implemented and described in the document WO 2008/012479 A1, associated to a method of 3D reconstruction of the surface of the back and allowing establishing the relationships between the spine and the back surface at this time t. However, any other method of 3D reconstruction of the spine and of the spine/back surface relationships may be implemented at this previous time t.

The objective of the dynamic spine model of the present invention is to allow determining a personalized 3D configuration of the spine, knowing the configuration of the spine and of the surface of the back at a previous time t, as well as the configuration of the surface of the back at a final time t+1.

The invention thus relates to a method for dynamically determining the position and orientation of the bone elements of the spine of an individual by internal imaging, in particular radiological imaging with digitization of 2D radiographs of the spine, and 3D external imaging of the surface of said individual's back and calculations by a calculation means, the spine being formed of a stack of vertebrae articulated to each other, each of the articulations being liken to a ball joint between two adjacent vertebrae with an articular stiffness expressed as a matrix.

According to the invention, at a first time corresponding to a determined time t, the static position and orientation of each of the spine vertebrae, as well as the back surface geometry, are calculated for said determined time t, by an imaging method, so as in particular to be capable of determining the relationships of the vertebrae between each other and with respect to the surface of the back and at least one reference point of said surface of the back, and equations of a dynamic mechanical model of the spine formed by articulations between the vertebrae, as well as those linked to forces and/or constraints internal to the spine and to forces and/or constraints of interaction between the spine and the surface of the back, are determined, by modeling, the spine being modeled as a vector of parameters giving the position and orientation of each vertebra, and

at a second time corresponding to a determined time t+1, the spine having been displaced and/or deformed, by replacing the reference point(s) on the surface of said individual's back, 3D images of the external surface of said individual's back are made and digitized, and
for said time t+1, the position and orientation of each of the vertebrae are calculated based, on the one hand, on 3D image data of the external surface of the back at the time t+1, and on the other hand, on static position and orientation data of each of the vertebrae, as well as the back surface geometry at the time t, by solving the dynamic model of the spine represented by the equations thereof with application of forces and constraints,
the forces and constraints being, on the one hand, forces and constraints internal to the spine, and being then kinematic constraints linked to the links between the vertebrae and articular stiffnesses,
the forces and constraints being, on the other hand, forces and constraints of interaction between the spine and the surface of the back, and being then motor constraints linked to the displacement of the reference point(s) and forces dues to the linear stiffnesses for the vertebrae/back surface distance and the angular stiffnesses for the vertebrae/back surface orientation.

In various embodiments of the invention, the following means are used, which can be used either alone or in any technically possible combination thereof:

at the first time corresponding to the determined time t, a set of 2D radiographs of the spine and of 3D images of the surface of the individual's back is taken and digitized, external visual marks visible in the external images and in radiography being arranged on the surface of the individual's back, at least one of the visual marks being a reference point corresponding to the projection on the surface of the back of an anatomical point located along the spine of said individual and determinable by an operator, the static position and orientation of each of the vertebrae of the spine, as well as the back surface geometry, are calculated, so as in particular to be capable of determining the relationships of the vertebrae between each other and with respect to the surface of the back, including at least said at least one reference point,

as an alternative to 2D radiography, any other method of radiological imaging, including 3D imaging such as computed tomography (X scanner), or even nuclear magnetic resonance (MRI), may be implemented, to obtain at least the static position and orientation of each of the vertebrae of the spine at the time t,

the reference point visible in external imaging of the surface of the back is also visible in radiology,

the reference point visible in external imaging of the surface of the back is not visible in radiology,

the spine model is a vector of twelve parameters per vertebra, said parameters being: a vector uᵢ of a postero-anterior axis of the vertebra local coordinate system, expressed in a global coordinate system,

a vector vᵢ of a transverse axis of the vertebra local coordinate system, expressed in a global coordinate system,
a vector r_{Ui} of the coordinates of the center of the articulation between the vertebra i and the superior vertebra (i+1), expressed in the global coordinate system, and
a vector r_{Di} of the coordinates of the center of the articulation between the vertebra i and the inferior vertebra (i−1), expressed in the global coordinate system, said parameters being constrained to each other, each vertebra being considered as a rigid body, said rigid-body constraints being expressed by the following relations:

uᵢ²−1=0

vᵢ²−1=0

(r_{Ui}−r_{Di})²−Lᵢ²=0

uᵢvᵢ=0

uᵢ(r_{Ui}−r_{Di})−Lᵢ cos βᵢ=0

vᵢ(r_{Ui}−r_{Di})−Lᵢ cos αᵢ=0,

the values Lᵢ, αᵢ and βᵢ being fixed and calculated at the initial time t,

each of the vectors uᵢ, vᵢ, r_{Ui} and r_{Di} is a 3×1 vector,

the twelve parameters, subjected to the above-mentioned rigid-body constraints, give six degrees of freedom to each vertebra of the spine model,

the vector uᵢ is that of a local coordinate system axis oriented toward the front of the vertebra,

the vector uᵢ is that of a local coordinate system axis oriented toward the rear of the vertebra,

the vector vᵢ of the vertebra local coordinate system is oriented toward the left of the vertebra,

the vector vᵢ of the vertebra local coordinate system is oriented toward the right of the vertebra,

the kinematic constraints express the fact that the inferior rotation center of a vertebra is merged with the superior rotation center of the adjacent inferior vertebra, said constraint being expressed by the following relation of the parameters of the vector modeling the spine: r_{Di}−r_{Ui-1}=0, wherein r_{Ui} is the coordinate vector of the center of the articulation between the vertebra i and the superior vertebra (i+1), expressed in the global coordinate system, and r_{D}, is the coordinate vector of the center of the articulation between the vertebra i and the inferior vertebra (i−1), expressed in the global coordinate system,

the constraints linked to the intervertebral articular stiffnesses are expressed by the equation:

$$\vert \begin{matrix}{M}_{u} \\ {M}_{v} \\ {M}_{w}\end{matrix} \vert = - [ \begin{matrix}{k}_{uu} & 0 & {k}_{uw} \\ 0 & {k}_{vv} & 0 \\ {k}_{wu} & 0 & {k}_{ww}\end{matrix} ] \vert \begin{matrix}{θ}_{u} \\ {θ}_{v} \\ {θ}_{w}\end{matrix} \vert$$

wherein M represents articular moments in the local coordinate system, and then expressed in the global coordinate system, k represents angular stiffnesses and θ corresponds to the intervertebral angular variations in the relative movement between the times t and t+1,

the motor constraints are defined by the displacements of several reference points along the spine,

the motor constraints are defined by the displacements of a single reference point along the spine,

each reference point corresponds to the projection of the spinous process of a determined vertebra on the surface of the individual's back,

the motor constraints are defined by the displacements of a single reference point along the spine, said reference point corresponding to the projection of the C7 vertebra spinous process on the surface of the individual's back,

the stiffnesses of interaction between the spine and surface of the back are modeled using return springs on which forces are applied, the force linked to the vertebra/back surface distance corresponding for each vertebra to a spring-back equation

Fₚ=−kᵥ₋ₚₑₐᵤ*(rEᵢ−proj_{—}Epᵢ),

wherein Fₚ is a spring-back force in the global coordinate system, kᵥ₋ₚₑₐᵤ is a linear stiffness, rEᵢ is the projection of the center of the vertebral body of the vertebra on the line of the vertebral spinous processes in the initial position at time t, and proj_Epᵢ is the projection of the center of the vertebral body on the line of the vertebral spinous processes in the final position at time t+1, and the force linked to the vertebra/back surface orientation corresponding, for each vertebra, to a spring-back equation

mₜₒᵣₛᵢₒₙ=−kₜₒᵣₛᵢₒₙ*(θ_{vertébre}−θ_{gibbosité}),

wherein mₜₒᵣₛᵢₒₙ is a spring-back moment along the Z axis of the vertebra local coordinate System, kₜₒᵣₛᵢₒₙ is an angular stiffness, θ_{vertébre} is a vertebral rotation angle, and θ_{gibbosité} is a gibbosity angle, the resolution of said equations about the spring-back of the spine with the surface of the back between the two times allowing calculating the stresses applied to the vertebrae of the spine during the deformation and/or displacement thereof between the two times,

Mₜₒᵣₛᵢₒₙ is the expression of mₜₒᵣₛᵢₒₙ in the global coordinate system,

the equation of the dynamic mechanical model of the spine is:

$$\{ \begin{matrix}φ = 0 \\ [ M ] [ \ddot{q} ] + {[ K ]}^{T} [ λ ] = [ Q ]\end{matrix}$$

wherein:
φ is the vector of the rigid-body, kinematic and motor constraints,
M is the matrix of the vertebra masses,
q″ is the vector of the accelerations of the parameters q,
K is the Jacobian of the constraint vector,
λ is the vector of the Lagrange multipliers, and
Q is the vector of the generalized stresses corresponding to the stresses due to the articular stiffnesses and the stiffnesses of interaction between the spine and surface of the back, and the conditions of static equilibrium apply:

[K]^{T}[λ]−[Q]=[0]

Et[θ]=[0],

the mass matrix M is calculated as a function of the geometry and the mass of each of the vertebrae,

the geometry of each vertebra is calculated/estimated based on the results of the 3D reconstruction of the spine at time t,

the mass is determined as a function of the calculated volume of the vertebra and of a determined value of bone density,

the resolution of the equation of the dynamic mechanical model of the spine is obtained either by a constrained optimization method, wherein the constraints to be respected are the rigid-body constraints, the kinematic constraints and the motor constrains, and the function to be minimized is the potential energy due to the articular stiffnesses and the stiffnesses of interaction between the spine and the surface of the back, or by a method of iterative resolution of integration of the dynamics equations, the equation of the dynamic mechanical model of the spine being solved by resolution of the system:

$$\vert \begin{matrix}\ddot{q} \\ λ\end{matrix} \vert = {[ \begin{matrix}[ M ] & {[ K ]}^{T} \\ [ K ] & [ 0 ]\end{matrix} ]}^{- 1} \vert \begin{matrix}[ Q ] \\ [ - [ \dot{K} ] \dot{q} ]\end{matrix} \vert$$

wherein \ddot{q} is the acceleration, \dot{q} is the speed of the parameters q over time, integrations of the accelerations and speeds over time making it possible to determine the speeds \dot{q} and the parameters q until the second time t+1,

further, for said time t+1, the back surface geometry at the time t+1 is calculated, and to calculate the position and orientation of each of the vertebra at a time subsequent to t+1, based on 3D images of the external surface of said individual's back, taken at said subsequent time, and while putting back the reference point(s) on the surface of said individual's back, the results of calculation of the position and orientation of each of the vertebrae and the back surface geometry at the previous time, obtained based on 3D images of the external surface of said individual's back, taken at said previous time, are used,

the modeling is made once for all,

the modeling is made on demand,

the modeling is adapted to each individual,

the calculation means includes several models for the dynamic mechanical model of the spine and/or for the internal constraint models and/or for the models of constraints of interaction of the spine with the surface of the back and/or for the parameter vector,

the calculation means performs several determinations with the different models,

the external 3D images are taken by implementation of an imaging technique that may be optical, for example.

The invention also relates to a device specially adapted and configured for implementing the method of the invention.

The present invention, without being limited thereby, will now be illustrated by the following description, in relation with:

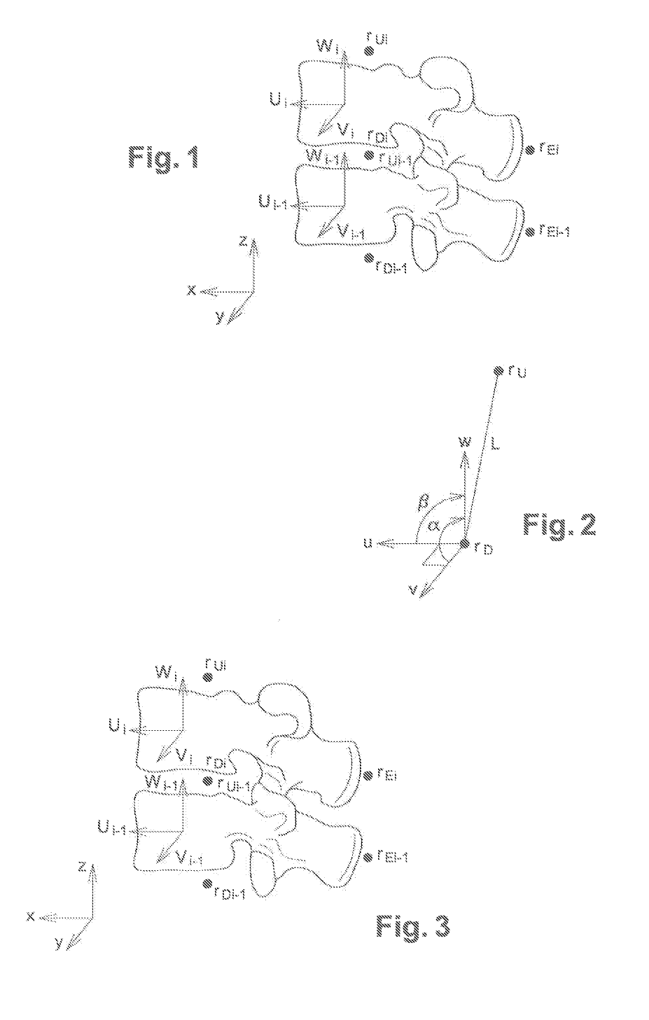

FIG. 1, which schematically illustrates the parameterization of the vertebrae in so-called natural coordinates,

FIG. 2, which schematically illustrates the rigid-body constraints,

FIG. 3, which schematically illustrates the kinematic constraints,

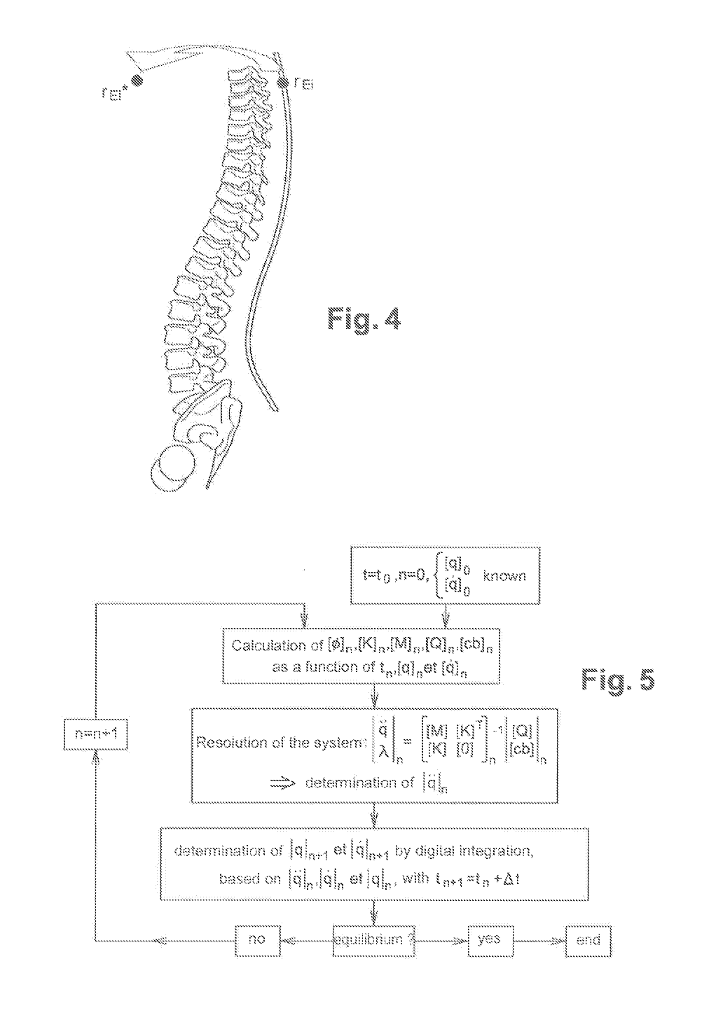

FIG. 4, which schematically illustrates the taking into account of motor constraints in the dynamic model, as the displacement of a determined point of the spine between the initial position r_{E}, at time t and the final position r_{Ei}* at time t+1, such positions being known due to the marking (reference point(s)) thereof and acquisitions,

FIG. 5, which schematically illustrates a method of solving the dynamics equations of the dynamic model taking the constraints into account,

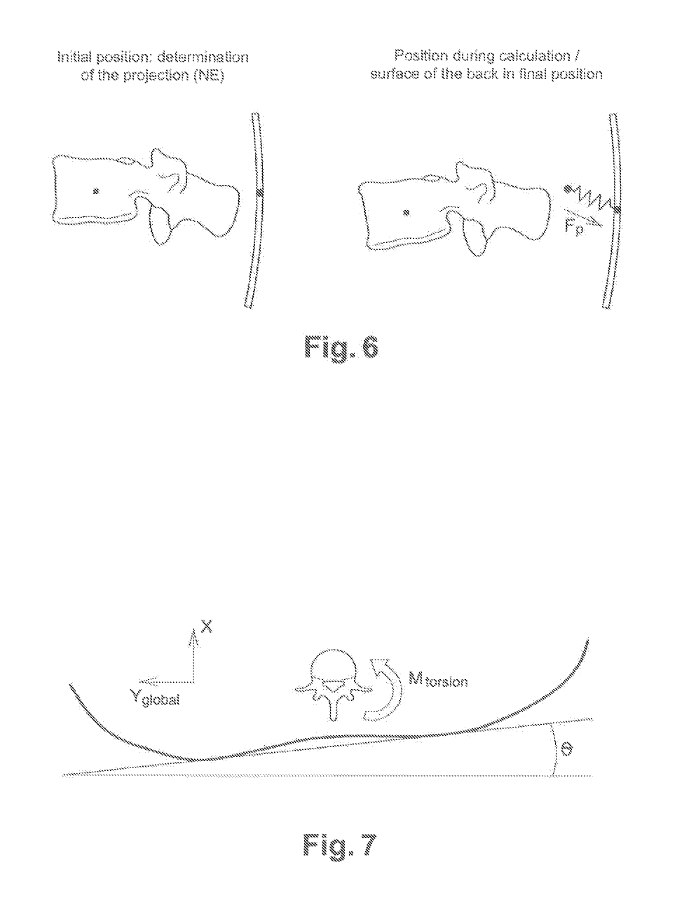

FIG. 6, which schematically illustrates the forces of interaction between the spine and the surface of the back, of the linear stiffness type, for the vertebra/back surface distance,

FIG. 7, which schematically illustrates the forces of interaction between the spine and the surface of the back, of the angular stiffness type, for the vertebra/back surface orientation, and

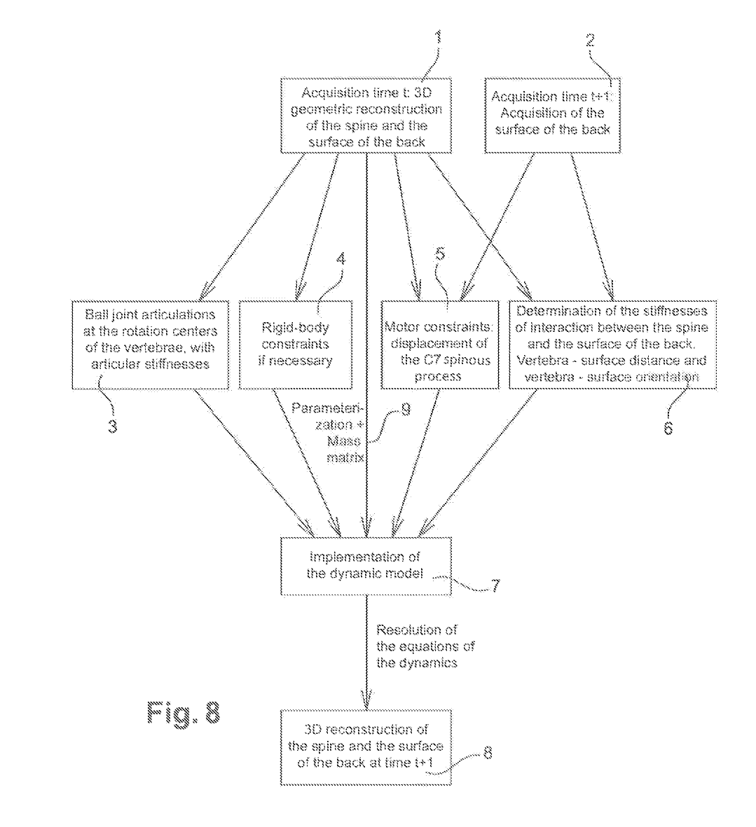

FIG. 8, which schematically illustrates the whole method for dynamically predicting the spine configuration.

Hence, the invention relates to a method for dynamically determining the position and orientation of the bone elements of the spine of an individual by internal imaging, in particular radiological imaging with digitization of 2D radiographs of the spine, and 3D external imaging of the surface of said individual's back and calculations in a calculation means, in particular a computer program in a (micro-)computer. Within its principle, the equations of a dynamic mechanical model of the spine and of constraints internal to the spine and of interaction of the spine with the surface of the back are determined, and, at a first time t, by means, in particular, of 2D radiographs of the spine, and of 3D images of the surface of the back, the relationships of the vertebrae between each other and with respect to the surface of the back are calculated, and at a second time t+1, 3D images of the external surface of said individual's back are taken, and the position and orientation of each of the vertebrae are calculated for said time t+1 based, on the one hand, on the data acquired from 3D images of the external surface of the back at the time t+1, and on the other hand, on the calculated data of static position and orientation of each of the vertebrae as well as the back surface geometry at the time t, by solving the dynamic model of the spine represented by its equations with application of forces and of constraints internal to the spine, being then kinematic constraints linked to the links between the vertebrae and articular stiffnesses, and with application of forces and of constraints of interaction between the spine and the surface of the back, being then motor constraints linked to the displacement of the reference point(s) and linear stiffnesses for the vertebra/back surface distance and angular stiffnesses for the vertebra/back surface orientation.

The dynamic model used for the implementation of the invention is established based on the geometry of the spine (bone skeleton) and of the back (surface of the back) obtained upon an initial acquisition (position and orientation of the vertebrae, surface of the back) at a first, previous, time referred to as t.

To obtain the initial data to be processed, it may be used, for example, a system of spin and back surface 3D reconstruction using calibrated biplanar radiographs and simultaneous Moiré fringe optical acquisitions, as explained in the application WO 2008/012479 A1.

For that purpose, at this first, previous, time t, two biplanar radiographs of the spine is taken, a front one and a profile one, as well as a surface imaging with three-dimensional acquisition of the surface of the back by a Moiré fringe technique. Marks visible in radiology and in surface imaging are placed on the subject. Moreover, at least one reference point visible in surface imaging is placed, which corresponds to the projection of a reference point of the spine on the surface of the back. A computer equipment processes the data thus obtained, for three-dimensional reconstruction of the spine and merging with the surface of the back, in particular so that the relationships between the elements of the spine and the surface of the back can be established. More generally, at the previous time t, any method for 3D reconstruction of the spine and of the relationships of the spine with the surface of the back may be implemented, including radiology and magnetic resonance for 2D, or even 3D, internal imaging, and laser or Moiré for 3D external imagery, for example.

Then, at a second time, to obtain the final data to be processed, i.e. at the time t+1, after movement/deformation of the spine with respect to the first, previous, time t, it may for example be used a reconstruction of the surface of the back coming from a Moiré fringe optical acquisition. Therefore, at this second time t+1 (or the following times), only one (some) external surface-imaging acquisition(s) with three-dimensional acquisition of the surface of the back is (are) implemented, and no radiograph is required. More generally, any imaging technique for 3D reconstruction of the surface of the back may be implemented at the time t+1, and not only the Moiré technique.

The dynamic model, which is given hereinafter, takes into account several variables, including the position and orientation of the vertebra of the spine. The model is therefore parameterized so that each vertebra can be described by its position and orientation. For that purpose, at least 3 parameters are used to describe in position and orientation a given vertebra, if the articulations are supposed being ball joints. In this case, no kinematic constraint is required. It is to be noted that, if the parameterization uses more than 6 parameters per vertebra, these parameters have then to be linked to each other, not only by means of kinematic constraints, but also by means of rigid-body constraints. In all the cases, the spine is described by a vector q containing the whole parameters for all the vertebras.

By way of example of parameterization, it will be used a parameterization with 12 parameters per vertebra, and thus with associated kinematic and rigid-body constraints.

This example of parameterization in relation with FIG. 1 uses natural coordinates and, in this case, for the spine, each vertebra is defined by two points and two vectors, as follows:

uᵢ, the vector of the vertebra local coordinate system (cf. I. A. Stokes, “Three-dimensional terminology of spinal deformity. A report presented to the Scoliosis Research Society by the Scoliosis Research Society Working Group on 3-D terminology of spinal deformity,” Spine, vol. 19, pp. 236-48, 1994), oriented toward the front of the vertebra, expressed in the global coordinate system (3×1 vector),

vᵢ, the vector of the vertebra local coordinate system oriented toward the left of the vertebra, expressed in the global coordinate system (3×1 vector),

r_{Ui}, the vector of the coordinates of the center of the articulation between the vertebra i and the superior vertebra (i+1), expressed in the global coordinate system (3×1 vector),

r_{Di}, the vector of the coordinates of the center of the articulation between the vertebra i and the inferior vertebra (i−1), expressed in the global coordinate system (3×1 vector).

Accordingly, the spine description implemented in this example comprises 12 parameters per vertebra for 6 degrees of freedom and, in this case, 6 rigid-body constraints have to be introduced as schematically illustrated in FIG. 2:

uᵢ²−1=0

vᵢ²−1=0

(r_{Ui}−r_{Di})²−Lᵢ²=0

uᵢvᵢ=0

uᵢ(r_{Ui}−r_{Di})−Lᵢ cos βᵢ=0

vᵢ(r_{Ui}−r_{Di})−Lᵢ cos αᵢ=0,

Lᵢ, αᵢ, and βᵢ being fixed and determined at the previous time t.

The spine being formed of a series of articulations between vertebrae, kinematic constraints linked to these articulations are taken into account in the model. For that purpose, it is considered that articulations, of the ball joint type, are placed between the vertebrae (cf. Y. Petit, C-E. Aubin, H. Labelle, “Patient-specific mechanical properties of a flexible multi-body model of the scoliotic spine”, Medical & Biological Engineering & Computing, vol. 42, pp. 55-60, 2004). For each vertebra, three constraints, referred to as kinematic constraints, are introduced to describe such articulations.

By way of example of kinematic constraints, reference will be made to the case of vertebrae parameterized with natural coordinates as schematically illustrated in FIG. 3. These kinematic constraints impose that the inferior rotation center of a vertebra is merged with the superior rotation center of the adjacent inferior vertebra: r_{Di}−r_{Ui-1}=0.

The dynamic model also takes into account the articular stresses between the vertebrae. Those articular efforts are linked to articular stiffnesses. In the spine example spine, they are introduced to describe the stresses due to the rotations of the vertebrae relative to each other. Such articular stiffnesses may typically be of the type of those presented in the document of Y. Petit, C-E. Aubin, H. Labelle, “Patient-specific mechanical properties of a flexible multi-body model of the scoliotic spine”, Medical & Biological Engineering & Computing, vol. 42, pp. 55-60, 2004. Such articular stiffnesses are expressed by:

$$\vert \begin{matrix}{M}_{u} \\ {M}_{v} \\ {M}_{w}\end{matrix} \vert = - [ \begin{matrix}{k}_{uu} & 0 & {k}_{uw} \\ 0 & {k}_{vv} & 0 \\ {k}_{wu} & 0 & {k}_{ww}\end{matrix} ] \vert \begin{matrix}{θ}_{u} \\ {θ}_{v} \\ {θ}_{w}\end{matrix} \vert$$

wherein M represents articular moments, k represents articular stiffnesses and θ corresponds to the intervertebral angular variations in the relative movement between the times t and t+1.

We have just seen the forces and the constraints internal to the spine, which are considered for the resolution of the dynamic model. Forces and constraints of interaction between the spine and the surface of the back are also considered for solving the dynamic model.

In order to facilitate the resolution of the dynamic mode, the displacement of one or several determined points of the spine between their initial position (at the previous time t) and final position (at the time t+1) may also be measured. In practice, the number of determined points whose displacements are measured is reduced, a few determined points, and preferably reduced to a single determined point. Typically, this determined point is in relation with the projection of the C7 vertebra spinous process on the surface of the back, such projection being known and marked on the surface of the back at the times t and t+1 and corresponding to the reference point. This known displacement is a constraint, referred to as a motor constraint, and will be applied to the model so that the resolution of the latter leads to such a displacement.

Therefore, in FIG. 4, motor constraints impose the displacement of a known point (projection of the C7 spinous process on the surface of the back) between the final positions r_{Ei}*, known due to the marking thereof and to acquisitions, and its position r_{Ei} calculated by the model.

The forces of interaction between the spine and the surface of the back are, on the one hand, linear stiffnesses for the vertebra/back surface distance, and on the other hand, angular stiffnesses for the vertebra/back surface orientation.

As regards the linear stiffnesses for the vertebra/back surface distance, they are implemented as follows. In initial position (time t), the projection of the vertebra on the vertebral spinous process line (point of the vertebral spinous process line that is the closer to the vertebral center) is calculated for each vertebra and the position of each projection is determined in the vertebral coordinate system (coordinates NE in FIG. 6). Then, in the calculation, these coordinates NE allow calculating the coordinates rE (projection of the vertebra at the time t) in the global coordinate system. These coordinates are compared to those of the projection of the vertebra on the vertebral spinous process line in final position (known). A force Fₚ is applied to the vertebra, simulating a spring tending to bring the projection back to the target point of the vertebral spinous process line. This force is expressed by the following relationship:

Fₚ=−kᵥ₋ₚₑₐᵤ*(rEᵢ−proj_{—}Epᵢ)

where kᵥ₋ₚₑₐᵤ is a stiffness and proj_Epᵢ is the projection of the vertebra on the vertebral spinous process line in the final position.

This implementation is schematically illustrated in FIG. 6, in which, on the left, the vertebra and the surface of the back are in their initial positions (time t) and the projection is determined, and, on the right, during a step of calculation, it is tended to bring back the vertebra to its final position, the surface of the back being at its final position (t+1), still regarding the projection.

As regards the angular stiffnesses for the vertebra/back surface orientation, they are implemented as follows. For each vertebra, a section of the back surface is defined by the intersection between this surface and the plane (center vertebra, x_{local}, y_{global}). A gibbosity angle is defined between the tangent to the back surface and the vector y of the global coordinate system. A moment is then applied about the z axis of the vertebra to make the orientation of the vertebra coincide with the gibbosity angle.

mₜₒᵣₛᵢₒₙ=−kₜₒᵣₛᵢₒₙ*(θ_{vertébre}−θ_{gibbosité}).

mₜₒᵣₛᵢₒₙ is then expressed in the global coordinate system and is designated by Mₜₒᵣₛᵢₒₙ.

This implementation is schematically illustrated in FIG. 7.

The stresses calculated for these two interactions between the spine and the surface of the back by means of springs are taken into account in the dynamic model.

The dynamic model applied in the present invention is expressed as dynamics equations that must be solved by application of the above-mentioned forces and constraints and of data that are the results obtained at the first, previous, time t, of 3D reconstruction of the spine and of the surface of the back. These equations to be solved are:

$$\{ \begin{matrix}φ = 0 \\ [ M ] [ \ddot{q} ] + {[ K ]}^{T} [ λ ] = [ Q ]\end{matrix} \qquad ( Equation 1 )$$

wherein:

φ is the constraint vector (rigid-body, kinematic, motor, constraints, for example on C7),

M is the mass matrix (calculated as a function of the geometry and mass of the vertebrae)

q″ is the vector of the accelerations of the parameters q

K is the Jacobian of the constraint vector

λ is the vector of the Lagrange multipliers (unknown),

Q is the vector of the generalized stresses that includes the stresses due to the articular stiffnesses and the stiffnesses of interaction between the spine and the surface of the back.

Furthermore, it is considered that, at static equilibrium, the potential energy of the system is minimum. There results that, at static equilibrium, the parameters must respect the following equations:

[K]^{T}[λ]−[Q]=[0]

Et[φ]=[0] (Equation 2)

and the potential energy of the system is then minimum.

Any method of resolution of the dynamics equations may be used, as for example:

(1) constrained optimization, where the constraints to be respected are the rigid-body, kinematic, motor (for example on C7) constraints, and the function to be minimized is the potential energy due to the articular stiffnesses and to the stiffnesses of interaction between the spine and the surface of the back.
(2) resolution by iterative integration of the dynamics equations. Therefore, the resolution of the system:

$$\vert \begin{matrix}\ddot{q} \\ λ\end{matrix} \vert = {[ \begin{matrix}[ M ] & {[ K ]}^{T} \\ [ K ] & [ 0 ]\end{matrix} ]}^{- 1} \vert \begin{matrix}[ Q ] \\ [ - [ \dot{K} ] \dot{q} ]\end{matrix} \vert \qquad ( Equation 3 )$$

allows determining the acceleration \ddot{q} at the time t when the parameters q and the speeds \dot{q} are known at the time t.

By integration of the accelerations and speeds, the speeds \dot{q} and the parameters q at the time t+Δt may then be determined. The iterations are then repeated until the equilibrium position at the time t+1 for solving the system. This iterative method is schematically shown in FIG. 5.

FIG. 8 summarizes the whole method for dynamically predicting the spine configuration based on a previous determination at time t and on the acquisition of the surface of the back at time t+1, using the presented dynamic model, solved thanks, in particular, to the taking into account of internal-external relationships between the elements of the spine and the surface of the back.

In FIG. 8, in the first, previous, time, it is simultaneously performed, at step 1, acquisitions at time t of biplanar radiographs (face+profile) and images of the surface of the back (in three dimensions, by a Moiré technique) of a subject. Once these acquisitions performed and the data digitized for processing in a computer equipment, at step 2, the three-dimensional geometrical reconstitution of the spine and of the surface of the back is performed. With such reconstitutions, it is therefore possible to know the relationships between the elements of the spine and the surface of the back at time t. This step 1 is performed using the method and the calibration means presented in the application WO 2008/012479 and with one/several reference points.

It is reminded that, in this application WO 2008/012479, the computerized imaging method that is presented allows a three-dimensional reconstruction based on two-dimensional radiological images. For that purpose, a set of visual marks detectable by a surface sensor for acquiring three-dimensional surface images of the subject are placed on the surface of the subject, the external visual marks being also radio-opaque. To each radiological image acquired is associated a corresponding surface image acquired substantially at the same time and an iterative process is implemented, which comprises a phase of incidence calculation and a phase of deformation calculation according to an iterative process intended to determine the relative positions of the radiological images and the surface images, as well as to perform a positioning in the three dimensions of the radiological images, supposing an absence of deformation of the subject, and intended to determine and correct on the radiological images the deformations of the subject for the relative positions determined in the phase of incidence calculation, the criterion for stopping the iteration being based on the difference between the 3D coordinates of the marks between two successive iterations. It is reminded that, for this time t, any other method allowing at least a 3D reconstitution of the spine may be used.

At a second time, t+1, the same subject, whose spine has been displaced, undergoes a new acquisition of three-dimensional images of the surface of his/her back at step 2. It will have been taken care, both at time t and at time t+1, to place at least one reference point along the spine. In practice, a single reference point is used, which corresponds to the projection of the spinous process of the vertebra C7 (7^{th} cervical vertebra) on the surface of the subject's back. This reference point, in relation with the C7 spinous process, will permit to define a motor constraint of displacement of the C7 spinous process to solve the dynamic model, as schematically shown at step 5.

The taking into account of the other constraints and forces is schematically illustrated:

at step 3, for what regards the implementation of articulations of the ball joint type at the rotation centers of the vertebrae and having articular stiffnesses,

at step 4, for what regards the rigid-body constraints, if it is necessary because the model uses more than six parameters,

at step 6, for what regards the stiffnesses of interaction between the spine and the surface of the back, these constraints being the linear stiffnesses for the vertebra/back surface distance and the angular stiffnesses for the vertebra/back surface orientation.

It has also been represented, in FIG. 8, the parameterization for obtaining the mass matrix through the relation 9, which allows the implementation of the dynamic model at step 7 by taking into account the various constraints that permit the resolution of the dynamics equations of the dynamic model at step 8 with a three-dimensional reconstruction of the spine and of the surface of the back of time t+1 and thus of the relationships thereof.

It is to be understood that it is possible to reiterate these operations to follow movements over time, for times t+2, t+3 . . . , the step 1 being nevertheless replaced by previous implementations of the invention, allowing, as at step 1, to obtain a 3D reconstruction of the spine and the surface of the back, but this time based on simple three-dimensional images of the surface of the back of the type similar to step 2.

If necessary, it is possible, during such subsequent reiterations using simple 3D images of the surface of the back, to insert a time with radiological images or another means of internal imaging to update the model and to readjust the measurements and calculations and to restart based on radiological results or on these other means. In all the cases, the subject will receive far less radiations than if the principle of FIG. 8 were simply repeated in a similar way (with each time a radiological imaging).

Of course, the present invention is not limited to the particular embodiments that have been described, but covers any variant and equivalent within to the scope thereof. It is therefore well understood that the invention may be declined according to many other possibilities without thereby departing from the scope of the invention defined by the description and the claims.

1. A method for dynamically determining the position and orientation of the bone elements of the spine of an individual by internal imaging, in particular radiological imaging with digitization of 2D radiographs of the spine, and 3D external imaging of the surface of said individual's back and calculations by a calculation means, the spine being formed of a stack of vertebrae articulated to each other, each of the articulations being liken to a ball joint between two adjacent vertebrae with an articular stiffness expressed as a matrix,
characterized in that
at a first time corresponding to a determined time t, the static position and orientation of each of the spine vertebrae, as well as the back surface geometry, are calculated for said determined time t, by an imaging method, so as in particular to be capable of determining the relationships of the vertebrae between each other and with respect to the surface of the back and at least one reference point of said surface of the back, and
equations of a dynamic mechanical model of the spine formed by articulations between the vertebrae, as well as those linked to forces and/or constraints internal to the spine and to forces and/or constraints of interaction between the spine and the surface of the back, are determined, by modeling, the spine being modeled as a vector of parameters giving the position and orientation of each vertebra, and
at a second time corresponding to a determined time t+1, the spine having been displaced and/or deformed, by replacing the reference point(s) on the surface of said individual's back, 3D images of the external surface of said individual's back are made and digitized, and
for said time t+1, the position and orientation of each of the vertebrae are calculated based, on the one hand, on 3D image data of the external surface of the back at the time t+1, and on the other hand, on static position and orientation data of each of the vertebrae, as well as the back surface geometry at the time t, by solving the dynamic model of the spine represented by the equations thereof with application of forces and constraints, the forces and constraints being, on the one hand, forces and constraints internal to the spine, and being then kinematic constraints linked to the links between the vertebrae and articular stiffnesses,
the forces and constraints being, on the other hand, forces and constraints of interaction between the spine and the surface of the back, and being then motor constraints linked to the displacement of the reference point(s) and forces dues to the linear stiffnesses for the vertebrae/back surface distance and the angular stiffnesses for the vertebrae/back surface orientation.

2. The method according to claim 1, characterized in that the spine model is a vector of twelve parameters per vertebra, said parameters being:
a vector uᵢ of a postero-anterior axis of the vertebra local coordinate system, expressed in a global coordinate system,
a vector vᵢ of a transverse axis of the vertebra local coordinate system, expressed in a global coordinate system,
a vector r_{Ui} of the coordinates of the center of the articulation between the vertebra i and the superior vertebra (i+1), expressed in the global coordinate system, and
a vector r_{Di} of the coordinates of the center of the articulation between the vertebra i and the inferior vertebra (i−1), expressed in the global coordinate system,
said parameters being constrained to each other, each vertebra being considered as a rigid body, said rigid-body constraints being expressed by the following relations:
uᵢ²−1=0
vᵢ²−1=0
(r_{Ui}−r_{Di}))²−Lᵢ²=0
uᵢvᵢ=0
uᵢ(r_{Ui}−r_{Di})−Lᵢ cos βᵢ=0
(r_{Ui}−r_{Di})−Lᵢ cos αᵢ=0,
the values Lᵢ, αᵢ and βᵢ being fixed and calculated at the initial time t.

3. The method according to claim 1, characterized in that the kinematic constraints express the fact that the inferior rotation center of a vertebra is merged with the superior rotation center of the adjacent inferior vertebra, said constraint being expressed by the following relation of the parameters of the vector modeling the spine:
r_{Di}−r_{Ui-1}=0,
wherein
r_{Ui} is the coordinate vector of the center of the articulation between the vertebra i and the superior vertebra (i+1), expressed in the global coordinate system, and
r_{Di} is the coordinate vector of the center of the articulation between the vertebra i and the inferior vertebra (i−1), expressed in the global coordinate system.

4. The method according to claim 1, characterized in that the constraints linked to the intervertebral articular stiffnesses are expressed by the equation:
$$\vert \begin{matrix}{M}_{u} \\ {M}_{v} \\ {M}_{w}\end{matrix} \vert = - [ \begin{matrix}{k}_{uu} & 0 & {k}_{uw} \\ 0 & {k}_{vv} & 0 \\ {k}_{wu} & 0 & {k}_{ww}\end{matrix} ] \vert \begin{matrix}{θ}_{u} \\ {θ}_{v} \\ {θ}_{w}\end{matrix} \vert$$
wherein M represents articular moments, k represents articular stiffnesses and θ corresponds to the intervertebral angular variations in the relative movement between the times t and t+1.

5. The method according to claim 1, characterized in that the motor constraints are defined by the displacements of a single reference point along the spine, said reference point corresponding to the projection of the C7 vertebra spine on the surface of the individual's back.

6. The method according to claim 1, characterized in that the stiffnesses of interaction between the spine and surface of the back are modeled using return springs on which forces are applied, the force linked to the vertebra/back surface distance corresponding for each vertebra to a spring-back equation
Fₚ=−kᵥ₋ₚₑₐᵤ*(rEᵢ−proj_{—}Epᵢ),
wherein
Fₚ is a spring-back force in the global coordinate system,
kᵥ₋ₚₑₐᵤ is a linear stiffness,
rEᵢ is the projection of the center of the vertebral body of the vertebra on the line of the vertebral spinous processes in the initial position at time t, and
proj_Epᵢ is the projection of the center of the vertebral body on the line of the vertebral spinous processes in the final position at time t+1,
and in that the force linked to the vertebra/back surface orientation corresponds, for each vertebra, to a spring-back equation
mₜₒᵣₛᵢₒₙ=−kₜₒᵣₛᵢₒₙ*(θ_{vertébre}−θ_{gibbosité}),
wherein
mₜₒᵣₛᵢₒₙ is a spring-back moment along the z axis of the vertebra local coordinate system,
kₜₒᵣₛᵢₒₙ is an angular stiffness,
θ_{vertébre} is a vertebral axial rotation angle, and
θ_{gibbosité} is a gibbosity angle,
the resolution of said equations about the spring-back of the spine with the surface of the back between the two times allowing calculating the stresses applied to the vertebrae of the spine during the deformation and/or displacement thereof between the two times.

7. The method according to claim 1, characterized in that the equation of the dynamic mechanical model of the spine is:
$$\{ \begin{matrix}φ = 0 \\ [ M ] [ \ddot{q} ] + {[ K ]}^{T} [ λ ] = [ Q ]\end{matrix}$$
wherein:
φ is the vector of the rigid-body, kinematic and motor constraints,
M is the matrix of the vertebra masses,
q″ is the vector of the accelerations of the parameters q,
K is the Jacobian of the constraint vector,
λ is the vector of the Lagrange multipliers, and
Q is the vector of the generalized stresses corresponding to the stresses due to the articular stiffnesses and the stiffnesses of interaction between the spine and surface of the back, and the conditions of static equilibrium apply:
[K]^{T}[λ]−[Q]=[0]
Et[φ]=[0].

8. The method according to claim 7, characterized in that the resolution of the equation of the dynamic mechanical model of the spine is obtained either
by a constrained optimization method, wherein the constraints to be respected are the rigid-body constraints, the kinematic constraints and the motor constrains, and the function to be minimized is the potential energy due to the articular stiffnesses and the stiffnesses of interaction between the spine and the surface of the back, or
by a method of iterative resolution of integration of the dynamics equations, the equation of the dynamic mechanical model of the spine being solved by resolution of the system:
$$\vert \begin{matrix}\ddot{q} \\ λ\end{matrix} \vert = {[ \begin{matrix}[ M ] & {[ K ]}^{T} \\ [ K ] & [ 0 ]\end{matrix} ]}^{- 1} \vert \begin{matrix}[ Q ] \\ [ - [ \dot{K} ] \dot{q} ]\end{matrix} \vert$$
wherein \ddot{q} is the acceleration, \dot{q} is the speed of the parameters q over time, integrations of the accelerations and speeds over time making it possible to determine the speeds \dot{q} and the parameters q until the second time t+1.

9. The method according to claim 1, characterized in that, further, for said time t+1, the back surface geometry at the time t+1 is calculated, and in that, to calculate the position and orientation of each of the vertebra at a time subsequent to t+1, based on 3D images of the external surface of said individual's back, taken at said subsequent time, and while putting back the reference point(s) on the surface of said individual's back, the results of calculation of the position and orientation of each of the vertebrae and the back surface geometry at the previous time, obtained based on 3D images of the external surface of said individual's back, taken at said previous time, are used.

10. A device specially configured for implementing the method according to claim 1.

11. The method according to claim 2, characterized in that the kinematic constraints express the fact that the inferior rotation center of a vertebra is merged with the superior rotation center of the adjacent inferior vertebra, said constraint being expressed by the following relation of the parameters of the vector modeling the spine:
r_{Di}−r_{Ui-1}=0,
wherein
r_{Ui} is the coordinate vector of the center of the articulation between the vertebra i and the superior vertebra (i+1), expressed in the global coordinate system, and
r_{Ui} is the coordinate vector of the center of the articulation between the vertebra i and the inferior vertebra (i−1), expressed in the global coordinate system.

12. The method according to claim 2, characterized in that the constraints linked to the intervertebral articular stiffnesses are expressed by the equation:
$$\vert \begin{matrix}{M}_{u} \\ {M}_{v} \\ {M}_{w}\end{matrix} \vert = - [ \begin{matrix}{k}_{uu} & 0 & {k}_{uw} \\ 0 & {k}_{vv} & 0 \\ {k}_{wu} & 0 & {k}_{ww}\end{matrix} ] \vert \begin{matrix}{θ}_{u} \\ {θ}_{v} \\ {θ}_{w}\end{matrix} \vert$$
wherein M represents articular moments, k represents articular stiffnesses and θ corresponds to the intervertebral angular variations in the relative movement between the times t and t+1.

13. The method according to claim 2, characterized in that the motor constraints are defined by the displacements of a single reference point along the spine, said reference point corresponding to the projection of the C7 vertebra spine on the surface of the individual's back.

14. The method according to claim 2, characterized in that the stiffnesses of interaction between the spine and surface of the back are modeled using return springs on which forces are applied, the force linked to the vertebra/back surface distance corresponding for each vertebra to a spring-back equation
Fₚ=−kᵥ₋ₚₑₐᵤ*(rEᵢ−proj_{—}Epᵢ),
wherein
Fₚ is a spring-back force in the global coordinate system,
kᵥ₋ₚₑₐᵤ is a linear stiffness,
rEᵢ is the projection of the center of the vertebral body of the vertebra on the line of the vertebral spinous processes in the initial position at time t, and
proj_Epᵢ is the projection of the center of the vertebral body on the line of the vertebral spinous processes in the final position at time t+1,
and in that the force linked to the vertebra/back surface orientation corresponds, for each vertebra, to a spring-back equation
mₜₒᵣₛᵢₒₙ=−kₜₒᵣₛᵢₒₙ*(θ_{vertébre}−θ_{gibbosité}),
wherein
mₜₒᵣₛᵢₒₙ is a spring-back moment along the z axis of the vertebra local coordinate system,
kₜₒᵣₛᵢₒₙ is an angular stiffness,
θ_{vertébre} is a vertebral axial rotation angle, and
θ_{gibbosité} is a gibbosity angle,
the resolution of said equations about the spring-back of the spine with the surface of the back between the two times allowing calculating the stresses applied to the vertebrae of the spine during the deformation and/or displacement thereof between the two times.

15. The method according to, characterized in that the equation of the dynamic mechanical model of the spine is:
$$\{ \begin{matrix}φ = 0 \\ [ M ] [ \ddot{q} ] + {[ K ]}^{T} [ λ ] = [ Q ]\end{matrix}$$
wherein:
φ is the vector of the rigid-body, kinematic and motor constraints,
M is the matrix of the vertebra masses,
q″ is the vector of the accelerations of the parameters q,
K is the Jacobian of the constraint vector,
λ is the vector of the Lagrange multipliers, and
Q is the vector of the generalized stresses corresponding to the stresses due to the articular stiffnesses and the stiffnesses of interaction between the spine and surface of the back, and the conditions of static equilibrium apply:
[K]^{T}[λ]−[Q]=[0]
Et[φ]=[0].

16. The method according to claim 2, characterized in that the resolution of the equation of the dynamic mechanical model of the spine is obtained either
by a constrained optimization method, wherein the constraints to be respected are the rigid-body constraints, the kinematic constraints and the motor constrains, and the function to be minimized is the potential energy due to the articular stiffnesses and the stiffnesses of interaction between the spine and the surface of the back, or
by a method of iterative resolution of integration of the dynamics equations, the equation of the dynamic mechanical model of the spine being solved by resolution of the system:
$$\vert \begin{matrix}\ddot{q} \\ λ\end{matrix} \vert = {[ \begin{matrix}[ M ] & {[ K ]}^{T} \\ [ K ] & [ 0 ]\end{matrix} ]}^{- 1} \vert \begin{matrix}[ Q ] \\ [ - [ \dot{K} ] \dot{q} ]\end{matrix} \vert$$
wherein q is the acceleration, \dot{q} is the speed of the parameters q over time, integrations of the accelerations and speeds over time making it possible to determine the speeds \dot{q} and the parameters q until the second time t+1.

17. The method according to claim 2, characterized in that, further, for said time t+1, the back surface geometry at the time t+1 is calculated, and in that, to calculate the position and orientation of each of the vertebra at a time subsequent to t+1, based on 3D images of the external surface of said individual's back, taken at said subsequent time, and while putting back the reference point(s) on the surface of said individual's back, the results of calculation of the position and orientation of each of the vertebrae and the back surface geometry at the previous time, obtained based on 3D images of the external surface of said individual's back, taken at said previous time, are used.
